(19) United States
(12) Patent Application Publication
(10) Pub. No.: US 2018/0370864 A1
(43) Pub. Date: Dec. 27, 2018

(54) AMMONIUM NITRATE FERTILISER COMPOSITION AND METHOD OF MAKING THEREOF

(71) Applicant: YARA INTERNATIONAL ASA, OSLO (NO)

(72) Inventor: Francois LEDOUX, Cormeilles en Parisis (FR)

(73) Assignee: YARA INTERNATIONAL ASA, OSLO (NO)

(21) Appl. No.: 16/063,528

(22) PCT Filed: Dec. 20, 2016
(86) PCT No.: PCT/EP2016/081940

§ 371 Date: Jun. 18, 2018

(30) Foreign Application Priority Data
Dec. 21, 2015 (NO) 20151761

(51) Int. Cl. C05C 1/02; C05G 3/00

(52) U.S. Cl. CPC C05C 1/02; C01F 7/005; C05G 3/0041

(57) ABSTRACT

Additives can be added to fertilizers to impart desirable characteristics. For example, a class of additives have been disclosed to stabilize the explosive potential of AN fertilizers are desirable, however, such additives can react with the AN fertilizer during its manufacture or during its storage. This is particularly the case where the additives contain carbonates, oxides, hydroxides, contain water of hydration or water locked within the structure (e.g. within an interlayer substructure). This reaction can be avoided if the additive has a passivation layer substantially covering the surface of the additive. The passivation layer, being substantially non-reactive and substantially insoluble, protects the additive so that the additive keeps its desired properties and the fertilizer keeps its quality. In other aspects, methods of making the fertilizer are provided.

### TECHNICAL FIELD

Generally, the instant disclosure relates to fertilizer compositions and methods of making and using the same. More specifically, the instant disclosure relates to blast suppressant and/or blast resistant ammonium nitrate fertilizer compositions, as well as methods of making and using the same.

### BACKGROUND OF THE INVENTION

Ammonium Nitrate (AN) fertilizer, combined with fuel oil (ANFO) or other fuels is a common explosive used throughout the world. Unfortunately, due to the availability of ammonium nitrate and fuels (such as fuel oil, powdered sugar, or aluminium powder), malicious parties (e.g. terrorists) are able to obtain these materials and utilize them in explosives (i.e. bombs and improvised explosive devices).

WO2015/073561 describes a class of additives that can be added to AN fertilizers, also referred to therein as “stabilizer material” that reduces, prevents or eliminates the AN fertilizer from being used as an ANFO-type explosive. Suitable stabilizer materials include a layered double hydroxide (LDH), apatite and combinations thereof. Preferred LDH compounds are listed as hydrotalcite and hydrocalumite and a preferred apatite is mentioned as hydroxyapatite.

### SUMMARY OF THE INVENTION

Additives may be incorporated within AN fertilizers to impart desirable characteristics on the AN fertilizer. For example, additives may be used as a stabilizing additive to reduce, prevent, or eliminate the potential for the AN fertilizer to be sued as an ANFO-type explosive. However, such additives can react with the AN fertilizer. This is particularly the case where such additives contain carbonates, oxides, hydroxides, contain water of hydration or water locked within the structure (e.g. within an interlayer substructure).

In some embodiments, a fertilizer composition is provided comprising an ammonium nitrate material; an additive wherein the additive contains at least one carbonate, oxide, hydroxide, water of hydration, or water locked within the additive; wherein the additive further comprises a passivation layer.

In more particular embodiments, the additive is a stabilizing additive. In some aspects, the additive is a layered double hydroxide or an apatite. More particularly, the additive is hydrocalumite, hydrotalcite, or hydroxyapatite.

In some embodiments, the additive is at least 12.5 wt % of the total fertilizer composition.

In some embodiments, the passivation layer is substantially non-reactive with the ammonium nitrate material. For example, the passivation layer may substantially cover the surface of the additive. In more particular embodiments, the passivation layer comprises at least one of calcium sulfate, calcium phosphate, magnesium sulfate, magnesium phosphate, or calcium fluoride.

In another aspect, a method is provided of making a fertilizer composition comprising providing an ammonium nitrate material; adding a mobile additive to the ammonium nitrate material; and adding a stabilizing additive to the ammonium nitrate material containing the mobile additive.

In more particular embodiments, the mobile additive is sulphuric acid, ammonium bisulfate, ammonium sulfate, aluminum sulfate, phosphoric acid, monoammonium phosphate, diammonium phosphate, hydrogen fluoride, fluorosilicic acid, or the like

In some embodiments, the stabilizing additive is a layered double hydroxide or an apatite. For example the stabilizing additive may be hydrocalumite, hydrotalcite, or hydroxyapatite.

In some embodiments, the mobile additive is less than 15 wt % of the ammonium nitrate material. In more particular embodiments, the mobile additive is from 1-10 wt % of the ammonium nitrate material, 2-5 wt % of the ammonium nitrate material, or 3-5 wt % of the ammonium nitrate material.

In some embodiments, the stabilizing additive is at least 12.5 wt % of the total fertilizer composition. More particularly, the stabilizing additive is at least 12.5 wt % to not greater than 20 wt % of the total fertilizer composition.

In another aspect, a method is provided comprising forming a passivation layer on a stabilizing additive; and adding the stabilizing additive with the passivation layer to an ammonium nitrate material.

### DETAILED DESCRIPTION OF THE INVENTION

Additives to stabilize the explosive potential of AN fertilizers are desirable, however, such additives can react with the AN fertilizer. This is particularly the case where such stabilizing additives contain carbonates, oxides, hydroxides, contain water of hydration or water locked within the structure (e.g. within an interlayer substructure).

As a generalization, and without limiting the generality of the foregoing, a reaction between the AN fertilizer and a metal oxide could proceed according to:

MO+NH₄NO₃→M(NO₃)₂+2 NH₃(g)+H₂O (1)

A similar type of reaction would be expected with carbonates, hydroxides, or structural water wherein the nitrate reacts therewith or displaces and potentially liberates water.

In the case of a LDH or apatite, when used as a stabilizing additive with the AN fertilizer to reduce the explosive potential, such reactions between the additive and the AN could lead to unwanted products with reduced ability of the additive to actually reduce the explosive potential. There is also the potential that the reaction could lead to process issues in the handling or storage of the AN fertilizer, independently on any effect on the properties of the additive itself. For example, the reaction with the AN fertilizer may lead to foaming of the AN fertilizer during its manufacture, leading to process issues and/or reduced quality of the final product. In this context, low quality may mean porosity and low density. In addition, or alternatively, and without being bound by theory, any released water may affect the consistency or storability of the fertilizer, or the ability of the additive to stabilize the explosive potential of AN fertilizers.

In certain embodiments, the metal nitrate may be soluble within the AN melt. For example, calcium nitrate or magnesium nitrate would be soluble within the AN melt.

Reactive additives can be protected from the bulk AN through the formation of a substantially non-reactive passivation layer on the surface of the additive. The passivation layer may be formed on the additive either prior to being added to the AN fertilizer or it can be formed in situ within the AN melt in which case, some minor reaction may still occur with the AN, in competition with the formation of the passivation layer.

In some embodiments, the passivation layer is formed in situ within the AN melt. For example, a mobile ion such as sulfate, phosphate or fluoride may be added to the AN melt prior to addition of the additive. In some embodiments, the mobile ion may be added to the AN melt in the form of a mobile additive. Examples of such a mobile additive would be as sulfuric acid, ammonium bisulfate, ammonium sulfate (AS), aluminum sulfate, phosphoric acid, monoammonium phosphate (MAP), diammonium phosphate (DAP), hydrogen fluoride (HF), fluorosilicic acid, or the like. In some embodiments, the AN melt may contain less than 15 wt % of mobile additive, less than 10 wt % of mobile additive, from 1-10 wt % of mobile additive, from 2-7 wt % of mobile additive, from 2-5 wt % of mobile additive, from 3-5 wt % of mobile additive.

In general, it has been observed that the amount of mobile ion added to the AN melt needs to greatly exceed the stoichiometric amount needed to cover the full surface of the additive, taking into account the steric and spatial occupation of the molecules forming the passivation layer.

Without being bound by theory, the mobile additive, while soluble within the AN melt, can react with the surface of the additive to form a passivation layer to protect the bulk of the additive and to prevent, reduce, or eliminate the ability of the stabilizing additive from reacting with the AN melt. For example, in certain embodiments when the additive contains calcium or magnesium, a passivation layer may form comprising calcium sulfate, calcium phosphate, magnesium sulfate, magnesium phosphate, calcium fluoride, as the case may be and depending on the nature of the mobile ion. Such passivation layers are preferably substantially non-reactive and substantially insoluble within the AN melt.

In some embodiments, the additive may be impregnated prior to addition to the AN melt. For example a calcium or magnesium nitrate may be used to impregnate the additive. In such a manner, the impregnation material may react with the mobile ion to form the passivation layer on the surface of the additive.

In some embodiments, a passivation layer is formed on the surface of the additive prior to being added to the AN melt. In other embodiments, the passivation layer may alternatively comprise a non-reactive coating applied to the additive.

As used herein, “layered double hydroxide” means: a class of compounds which are characterized by multiple (e.g. two) positively charged layers and weakly bound, often exchangeable central ion(s) (e.g. negatively charged ions) located in the interlayer (middle) region. As a non-limiting example, LDHs are commonly referred to by the following generic chemical formula:

[M²⁺₁₋ₓM³⁺ₓ(OH)₂]^{q+}(Xⁿ⁻)_{q/n-}*yH₂O (2)

As some non-limiting examples, z=2, M²⁺=Ca, Mg²⁺, Mn²⁺, Fe²⁺, Co²⁺, Ni²⁺, Cu²⁺, or Zn²⁺, (hence q=x).

Non-limiting examples of LDH compounds include: hydrotalcites, hydrocalumite, hydromagnesite, takovite, woolite, and combinations thereof.

As used herein, “intercalated” means: a substances which has another substance or material inserted between or among existing elements or layers. In some embodiments, an LDH is intercalated with its central/interlayer region being replaced with other anions or compounds.

Non-limiting examples of intercalated LDH (sometimes called iLDH) include: herbicides, pesticides, anti-fungal agents, supplemental nutrients (e.g. phosphorous compounds, nitrogen compounds, sulfur compounds, trace-element compounds, and combinations thereof). In some embodiments, the LDH is intercalated with a nitrate. In some embodiments, the LDH is intercalated with a sulfate. In some embodiments, the LDH is intercalated with a phosphate.

In some embodiments, LDH comprises hydrotalcite (HTC). In some embodiments, LDH comprises hydrocalumite.

As used herein, “hydrotalcite” means: a layered double hydroxide of the following formula:

Mg₆Al₂(CO₃)(OH)₁₆*4(H₂O) (3)

Non-limiting examples of groups of materials within the hydrotalcites supergroup include: hydrotalcites group, quintinite group, fougerite group, woodwardite group, glaucerinite group, cualstibite group, hydrocalumite group, and unclassified.

Non-limiting examples of hydrotalcites include: pyroaurite, stichtite, meixnerite, iowaite, droninoite, woodallite, desaurelsite, takovite, reevesite, jamborite, quintinite, charmarite, caresite, zaccagnaite, chrlomagaluminite, fougerite, woodwardite, zincowoodwardite, honessite, claucocerinite, hydrowoodwardite, carrboydite, hydrohonessite, mountkeithite, sincaluminite, wermlandite, shigaite, nikischerite, motukoreaite, natroglaucocerinite, karchevskyite, cualstibite, xincalstibite, hydroclumite, kuzelite, coalingite, brugnatellite, muskoxite, and combinations thereof.

Non-limiting examples of intercalated hydrotalcites (sometimes called iHTC) include: HTC-carbonate, HTC-phosphate, HTC-nitrate, and combinations thereof.

As used herein, “hydromagnesite” means: a magnesium carbonate mineral.

As used herein, “apatite” means: a phosphate mineral having calcium phosphate with some fluorine, chlorine, and other elements. In some embodiments, apatite is neutralized with group of phosphate minerals. One example of an apatite compound is hydroxyapatite.

In one embodiment, when the fertilizer composition has 10 wt. % of stabilizing additive and there are two stabilizing additives present (a first and a second), the content of first to second stabilizing additives are as follows: 2 wt. % of a first and 8 wt. % of a second or 5 wt. % of each of the first and the second.

In one embodiment, when the fertilizer composition has 15 wt. % of stabilizing additive and there are two stabilizing additives present (a first and a second), the content of first to second stabilizing additives are as follows: 5 wt. % of a first and 10 wt. % of a second, 7.5 wt. % of each of the first and the second.

In one embodiment, when the fertilizer composition has 20 wt. % of stabilizing additive and there are two stabilizing additives present (a first and a second), the content of first to second stabilizing additives are as follows: 5 wt. % of a first and 15 wt. % of a second, or 10 wt. % of each of the first and the second.

In one embodiment, when the fertilizer composition has 25 wt. % of stabilizing additive and there are two stabilizing additives present (a first and a second), the content of first to second stabilizing additives are as follows: 5 wt. % of a first and 20 wt, % of a second, 10 wt. % of a first and 15 wt, % of a second; 12.5 wt % of each of the first and the second.

In one embodiment, when the fertilizer composition has 30 wt. % of stabilizing additive and there are two stabilizing additives present (a first and a second), the content of first to second stabilizing additives are as follows: 5 wt. % of a first and 25 wt. % of a second, 10 wt, % of a first and 20 wt. % of a second; 15 wt. % of each of a first and second.

As used herein, “AN-type explosive” means: ammonium nitrate-based fuel explosives, where fuels include fuel oil (ANFO-type explosives) or other fuels like powdered sugar or aluminum powder.

As used herein, “fertilizer” means: a substance used to make soil more fertile. In some embodiments of the instant disclosure, a fertilizer includes ammonium nitrate. In other embodiments, fertilizer is ammonium nitrate fertilizer which includes at least one stabilizing additive, where the stabilizing additive has a passivation layer.

In some embodiments, the fertilizer composition of the instant disclosure is in a single form (i.e. pellets, prills, granules, disks, or powder). In some embodiments, the fertilizer composition of the instant disclosure is in multiple forms (i.e. a mixture of two or more forms, including pellets, pastilles, flakes, prills, granules, disks, or powder).

In some embodiments, the fertilizer composition comprises: a mesh size of 4, a mesh size of 6, a mesh size of 8, a mesh size of 10, a mesh size of 12, a mesh size of 14, a mesh size of 16, a mesh size of 18, or a mesh size of 20.

In some embodiments, the fertilizer composition comprises: a mesh size of 20, a mesh size of 30, a mesh size of 40, a mesh size of 50, a mesh size of 60, a mesh size of 70, a mesh size of 80, a mesh size of 90, or a mesh size of 100.

In some embodiments, the fertilizer composition comprises a homogenous mixture.

In some embodiments, the fertilizer composition comprises a heterogeneous mixture.

In some embodiments, the fertilizer compositions include: uncoated materials, coated materials, and/or multi-coated materials (i.e. more than one coating).

Generally, addition of a stabilizing additive in accordance with the instant disclosure causes blast suppression and/or a desensitization of the resulting fertilizer composition.

As used herein, “ammonium nitrate material” (also interchangeably referred to as AN) means: a composition including ammonium nitrate (NH₄NO₃). In some embodiments, ammonium nitrate is used in agriculture as a high-nitrogen fertilizer, though AN fertilizer can also be used as an oxidizing agent in explosives (e.g. including improved explosive devices).

As used herein, “stabilizing additive” means: a material added to another material to prevent or retard an unwanted alteration of physical state. In some embodiments, a stabilizing additive is present with an ammonium nitrate material to provide a fertilizer composition which prevents or retards an unwanted oxidation/explosion of the composition. In some embodiments, the stabilizing additive comprises an additive.

As used herein, “additive” means: a substance added to another in defined amounts to effect a desired change in one or more properties. In accordance with the instant disclosure, a “stabilizing additive” is added to a fertilizer comprising ammonium nitrate in order to prevent, reduce, or eliminate the ability of the composition to be utilized as a material (e.g. oxidizing material) in an explosive and/or explosive device. A “mobile additive” is added to the fertilizer to form a passivation layer in situ on the stabilizing additive in order to prevent, reduce or eliminate the ability of the stabilizing additive to react with the nitrate fertilizer.

As used herein, a “passivation layer” means a protective surface layer that is substantially non-reactive. All references to a stabilizing additive herein, unless otherwise indicated, refer to such a stabilizing additive comprising a passivation layer.

In some embodiments, the fertilizer composition comprises: at least 5 wt. % stabilizing additive; at least 7 wt. % stabilizing additive; at least 10 wt. % of stabilizing additive; at least 12.5 wt.% of stabilizing additive at least 15 wt. % of stabilizing additive; at least 20 wt. % of stabilizing additive; at least 25 wt. % of stabilizing additive; at least 30 wt. % of stabilizing additive; at least 35 wt. % of stabilizing additive; at least 40 wt. % of stabilizing additive; at least 45 wt. % of stabilizing additive; or at least 50 wt. % of stabilizing additive.

In some embodiments, the fertilizer composition comprises: not greater than 5 wt. % of stabilizing additive; not greater than 7 wt. % of stabilizing additive; not greater than 10 wt. % of stabilizing additive; not greater than 15 wt. % of stabilizing additive; not greater than 20 wt. % of stabilizing additive; not greater than 25 wt. % of stabilizing additive; not greater than 30 wt. % of stabilizing additive; not greater than 35 wt. % of stabilizing additive; not greater than 40 wt. % of stabilizing additive; not greater than 45 wt. % of stabilizing additive; or not greater than 50 wt. % of stabilizing additive.

In some embodiments, the fertilizer composition comprises a stabilizing additive in the form of particles having a volume based average particle size (d50) in the range of 0.1 to 500 μm as measured by conventional laser diffraction methods. The stabilizing additive may also have an average particle size (d50) in the range of 1 to 250 μm. The stabilizing additive may also have an average particle size (d50) in the range of 5 to 100 μm. These particle sizes are suitable for melt granulation techniques relying on low viscosity of the melt, e.g. prilling and drum granulation etc. If the stabilizing additive, in the form of solid particles having a volume based average particle size (d50) in the range of 0.1 to 500 μm, is mixed into an AN melt, it is possible to obtain fertilizer particles comprising a stabilized additive heterogeneously or homogeneously distributed in the AN. In contrast, AN particles comprising stabilizing additives in the coating only, may not stabilize the explosive potential equally good. Accordingly, in one embodiment, it is provided a solid fertilizer particle with a diameter in the range of 1 to 10 mm comprising more than 70% w/w AN and a solid stabilizing additive which is homogeneously distributed in the AN, wherein the stabilizing additive comprises a passivation layer substantially covering the surface of the stabilizing additive. As used herein, “explosive device” means: a device that provides for a sudden, loud, and violent release of energy that happens when the device (or material therein) breaks apart in such a way that sends parts flying outward. Non-limiting examples of explosive devices include bombs and/or improvised explosive devices.

As used herein, “detonation” means: the act or process of exploding of causing something to explode. In some embodiments, one or more stabilizing additives of the instant disclosure effect a reduction in or elimination of the detonation of ammonium nitrate material (e.g. utilized in an explosive device as an oxidizing material).

As used herein, “suppressant” means: an agent that tends to prevent, control, or reduce the intensity of a particular property of a material. In some embodiments, suppressant effects are quantified by measuring a reduction in specific impulse of a fertilizer composition, as compared to control (commercially available AN or AN fertilizer) or existing blast resistant fertilizers (e.g. CAN-27). In some embodiments, suppressant refers to a chemical mechanism of blast inhibition and/or prevention.

As used herein, “diluent” means: a diluting agent. In some embodiments, the stabilizing additives to the ammonium nitrate act as filler, thinning out the proximity of particles of ammonium nitrate from one another. In some embodiments, diluent refers to a mechanical mechanism of blast inhibition and/or prevention (i.e. dilution by addition of stabilizing additives which acts as a filler material).

As used herein, “substantially non-reactive” means: dimensionally stable. In some embodiments, substantially non-reactive means inert (non-reacting). Some non-limiting examples of substantially non-reactive stabilizing additives include: sand, clay (i.e. naturally occurring and/or synthetic clays), aggregate (i.e. rocks), and the like.

In some embodiments, the fertilizer composition includes a pH adjusting components. Non-limiting examples of pH adjusting components include: nitric acid, phosphoric acid, bauxite residue, ammonia, dolomite, etc.

In some embodiments, the fertilizer composition includes a plant nutrient. Non-limiting examples of plant nutrients include: N, P, K, Mg, Ca, S, trace elements (Fe, Mn, metals present in the stabilizing additive compounds), and combinations thereof.

These and other aspects, advantages, and novel features of the technology are set forth in part in the description that follows and will become apparent to those skilled in the art upon examination of the following descriptions and Figures, or is learned by practicing the embodiments of the instant disclosure.

### EXAMPLES

For all examples tested, UltraCarb from LKAB Minerals was used as an additive which is a combination of huntite and hydromagnesite. Huntite is a carbonate mineral with the chemical formula Mg₃Ca(CO₃)₄ and hydromagnesite is an LDH, specifically a hydrated magnesium carbonate mineral with the formula Mg₅(CO₃)₄(OH)₂.4H₂O.

### Example 1

50g of additive (UltraCarb) was added to 200 g AN and 2 g H₂O at 180° C. Significant foaming was immediately observed and the reaction stopped after 8 minutes.

### Example 2

37.5g of additive (UltraCarb) was slowly added over a period of approximately 5 minutes to a melt containing 200 g AN and 12.5 g of AS at 180° C. No foaming was observed over a period of 30 minutes.

### Example 3

42.5g of additive (UltraCarb) was slowly added over a period of approximately 2.5 minutes to a melt containing 200 g AN and 7.5 g of AS at 180° C. No foaming was observed over a period of 30 minutes.

### Example 4

45 g of additive (UltraCarb) was slowly added over a period of approximately 2.5 minutes to a melt containing 200 g AN and 5 g of AS at 180° C. A minor amount foaming, corresponding to approximately 2 cm was observed over a period of 30 minutes.

### Example 5

50 g of additive (UltraCarb) was slowly added over a period of approximately 4 minutes to a melt containing 187.5 AN and 12.5 g of AS at 180° C. A minimal amount of foaming was observed over a period of 30 minutes but not enough to measure.

These results are summarized in Table 1 below:

TABLE 1

| | | | | Reaction |
|---|---|---|---|---|
| | wt % | wt % | wt % | observed |
| | AN | AS | UltraCarb | visually |
| Example 1 | 80 | 0 | 20 | +++ |
| Example 2 | 80 | 5 | 15 | 0 |
| Example 3 | 80 | 3 | 17 | 0 |
| Example 4 | 80 | 2 | 18 | + |
| Example 5 | 75 | 5 | 20 | 0 to + |

+++: vigorous reaction observed;
+: minimal reaction observed;
0: no reaction observed

These results demonstrate that additives containing hydroxide, carbonate and water moieties are not stable when added to the AN melt. However, when AS or other similar components are present within the melt that can react with the surface of the additive and provide a passivation layer, then little to no reaction is observed.

### Example 6

Approximately 60 g of additive from UltraCarb was dried at 300° C. for 24 hours and a 3.9% weight loss was observed. The same sample was then heated at 500° C. for an additional 24 hours and a total weight loss of 21.7% was observed.

The additive from example 5, specifically a 55 g flake was washed in 1000 ml methanol and then dried at 105° C. for 1 hour. A weight loss of 0.7% was observed compared to the weight of the flake prior to drying. The sample was then dried at 300° C. for 16 h and an additional 3.0% weight loss was observed to give a total 3.7% weight loss. The sample was then dried for 2 hours at 350° C. to give an additional 0.7% weight loss (4.5% total weight loss). The sample was then dried for an additional 3 hours at 600° C. and an additional 17.7 weight loss was observed (21.5% total weight loss). A final drying step of 9 hours at 600° C. was then done to get a total weight loss of 24.6%.

Within experimental error, the weight losses observed with the additive from example 5 demonstrate that the bulk additive was protected from reaction with the ammonium nitrate.

The weight losses between the two different samples of additive were approximately the same indicating that a passivation layer was actually formed on the surface of the UltraCarb additive in example 5, protecting the additive from reacting with the AN melt and that apart from the surface of the additive itself, there was no substantial reaction taking place.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A fertilizer composition comprising:
a. an ammonium nitrate material;
b. an additive wherein the additive contains at least one carbonate, oxide, hydroxide, water of hydration, or water locked within the additive;
wherein the additive further comprises a passivation layer.

2. The fertilizer composition of claim 1 wherein the additive is a stabilizing additive.

3. The fertilizer composition of claim 2 wherein the stabilizing additive is a layered double hydroxide.

4. The fertilizer composition of claim 3 wherein the additive is hydrocalumite or hydrotalcite.

5. The fertilizer composition of claim 2 wherein the stabilizing additive is an apatite.

6. The fertilizer composition of claim 5 wherein the additive is a hydroxyapatite.

7. The fertilizer composition of claim 1 wherein the additive is at least 12.5 wt % of the total fertilizer composition.

8. The fertilizer composition of claim 1 wherein the passivation layer is substantially non-reactive with the ammonium nitrate material.

9. The fertilizer composition of claim 1 wherein the passivation layer substantially covers the surface of the additive.

10. The fertilizer composition of claim 1 wherein the passivation layer comprises at least one of calcium sulfate, calcium phosphate, magnesium sulfate, magnesium phosphate, or calcium fluoride.

11. A method of making a fertilizer composition comprising:
a. Providing an ammonium nitrate material;
b. Adding a mobile additive to the ammonium nitrate material;
c. Adding a stabilizing additive to the ammonium nitrate material containing the mobile additive.

12. The method of claim 11 wherein the mobile additive is sulphuric acid, ammonium bisulfate, ammonium sulfate, aluminum sulfate, phosphoric acid, monoammonium phosphate, diammonium phosphate, hydrogen fluoride or fluorosilicic acid.

13. The method of claim 11 wherein the stabilizing additive is a layered double hydroxide.

14. The method of claim 13 wherein the stabilizing additive is hydrocalumite or hydrotalcite.

15. The method of claim 11 wherein the stabilizing additive is an apatite.

16. The method of claim 15 wherein the stabilizing material is hydroxyapatite.

17. The method of claim 11 wherein the mobile additive is less than 15 wt. % of the ammonium nitrate material.

18. The method of one of claim 17 wherein the mobile additive is from 1-10 wt. % of the ammonium nitrate material.

19. The method of claim 17 wherein the mobile additive is from 2-5 wt. % of the ammonium nitrate material.

20. The method of claim 11 wherein the stabilizing additive is at least 12.5 wt. % of the total fertilizer composition.

21. The method of claim 20 wherein the stabilizing additive is at least 12.5 wt. % to not greater than 20 wt. % of the total fertilizer composition.

22. The method of claim 11 further comprising the step of impregnating the stabilizing additive with calcium nitrate or magnesium nitrate prior to the stabilizing being added to the ammonium nitrate material.

23. A method of making a fertilizer composition comprising
a. Forming a passivation layer on a stabilizing additive;
b. Adding the stabilizing additive with the passivation layer to an ammonium nitrate material.
